(19) United States
(12) Patent Application Publication
(10) Pub. No.: US 2007/0131174 A1
(43) Pub. Date: Jun. 14, 2007

(54) Cat4play indoor outdoor lite weight fat cat play house

(76) Inventor: Judy Faye Ray Coggins, Chula Vista, CA (US)

Correspondence Address: Judy Coggins Ray, 671 Arthur Ave., Chula Vista, CA, 91910, US

(21) Appl. No.: 11/299,190

(22) Filed: Dec. 9, 2005

(51) Int. Cl. A01K 15/02

(52) U.S. Cl. 119/706

(57) ABSTRACT

An indoor, outdoor, urine resistant, light weight, modular, cost friendly cat play house. FIG. (1A) base and FIG. (2A) tower about 2′ tall, 2′×2′ wide. Possible steel substance frame with about 1′ grid and five holes for enter and exit. Covered with EVA foam that cats prefer over carpet and wood is extraordinary. Cleaning and disinfecting comparison is tile flooring. Non toxic, anti fungal, heat and cold surface resistant and feels good too.

Replaceable, changeable and removable individual sections of EVA foam when damaged equal savings. Square shape to fit corners plus variety colors to meet any décor. Flights of neither stairs nor multiple cats all answered with cat4play. Seasonal and holiday colors connects cat4play with every family. Elderly can make cats their kids effortlessly with this light weight play house. FIG. (4) EVA foam pet carrier liners that also protect surfaces and substances. FIG. (5) EVA foam pet toys.

### CROSS-REFERENCE TO RELATED APPLICATIONS

Not Applicable

### FEDERAL SPONSORED RESEARCH

Not Applicable

### SEQUENCE LISTING OR PROGRAM

Not Applicable

### BACKGROUND OF INVENTION

1. Field of Invention

This invention relates to a low to moderate priced washable, urine resistant, indoor, outdoor, light weight environmentally friendly cat play house covered with special material cats prefer to insert claws over carpet and wood.

2. Prior Art

On the market are indoor cat scratches that are expensive, extremely heavy made of carpet, wood or rope with no means to disinfect. Washing surface is available an example is carpet cleaning solution, but does not relate to urine odors or diseased smelling germs from cats or dogs.

### BACKGROUND OF INVENTION—OBJECTS

Cat4play is environmentally friendly because all materials are recyclable. Cat4play has a base and tower total high about 3′ and total width about 2′ with EVA material that is urine and bacteria resistant and it can be located indoors or outdoors. Cats have about 5 places to enter or exit and they can scratch inside and out allowing them places to hide play and sleep. Cat4play's EVA material comes in a variety of colors some containing seasonal and holiday pictures and colors.

The EVA material is pre attached with Velcro and each section is cut to fit frame and can be removed individually to clean even replaced if damaged, keeping cost low to allow buying replacement mats without replacing entire structure. Cat4play can be turned in different directions hiding the damaged part to keep cost low. Holiday themes can be purchased, with Velcro pre attached allows them to be removed and stored away with all holiday items. Light in weight cat owners can treat their cats to extraordinary pleasure leaving behind fear they can't lift heavy items, carry them up flights of stairs, and not have a truck and strong person available. Less injury to everyone even those who think they can lift a cat scratchier.

Original cat scratchier disadvantage is when one side is damaged the cat scratchier is disposed of into our already over crowded land fills in a repetitious cycle for past decades. Future land fill space is limited and our future depends on environmentally friendly materials that can be recycled as is the entire Cat4play. Cat4play teaches cats Do Not Scratch Carpet or Wood. Cats are our kids, our family and we all want our kids to have fun and have play toys but don't want them destroying our furniture, especially our carpet. Cat4play answers all these issues and much more.

Cats are animals and love the outdoors but the outdoors is dangerous so to protect our kids we enclose patios or porches to give them the outdoor feel. Cat4play can be used outdoors it's water resistant; it can dry in the sun or mats removed and dried with a towel.

I run a pet rescue and pet adoption org where I often get sick animals with highly contagious deadly disease. I love to watch the cats play, it is truly one of the pleasures of my business but I am limited to toys that can be disinfected, we cannot afford to keep buying and replacing toys or post. I have also received so many cats because they are destroying their carpet and furniture. I never understood how to teach cats it's ok to scratch carpet on post but not carpet on floor. Cat4play teaches cats Do Not Scratch Carpet or Wood. Reducing the epidemic of over population of cats in our environment is critical and Cat4ply may play a major role in less relinquishes to our shelters and more adoptions. Cats are our kids our family and we all want our kids to have fun have play toys but don't want them destroying our furniture or our carpet.

This is the reason I came to invent Cat4play. I can disinfect it and allow other cats awaiting adoption places to play. I am disable with a bad back and single and had to have something I can move by myself and again cat4play works with my disability. Necessity is the mother of invention and I was in desperate need of this type of play house. Having an occasional dog raise their leg next to a cat cage or have a cat mark his territory, I had to come up with a material that was resistant to urine and easy to clean so I invented Cat4play. I never understood how to teach a cat to scratch the carpet on the scratchier but do not scratch the carpet on the floor.

### BACKGROUND OF INVENTION—ADVANTAGES

Accordingly, besides the objects and advantages of the Cat4play described in my above patent, several other objects and advantages are:
1. Cats prefer EVA foam mats to insert claws over carpet and wood.
2. Non toxic.
3. Anti fatigue is good for the cat's body.
4. Buy one frame it can be used over and over with new EVA mats available.
5. Scratching is inside and outside frame offering twice as much space to have fun.
6. Multiple cats have plenty of room to hide and play.
7. Light weight allows people to move and clean behind Cat4play or move to different rooms as rooms are always changing.
8. Military move often and Cat4play fits this family as in all families that have spouses away at war.
9. Multiple colors selections allows for match to any room décor and changes in room décor can be easily be achieved with the purchase of different colors. No need to replace the frame just replace the pads.
10. Extremely cost effective for every budget, EVA foam mat replacement is available at a fraction of the cost of other cat scratchier.
11. User friendly for all ages with Velcro attachments.
12. Cleaner friendly if no garden hose is available the shower works great.
13. Cost effective, Cat4play can be turned to hide the damaged area without taking away the entrance or exit holes.
14. Cost effective, two types of replacement pads will be available; the cheaper one is less dense and won't last as long, plus different colors in each type.
15. Cost effective, buy more than one it's affordable and the cats learn where they can play.
16. Holiday friendly, decorate Cat4play as you decorate your home for the holidays and after the holidays are over just remove Cat4play décor and store away with all holiday items.
17. Child friendly, if a child pulls it over it will not hurt them because it is to light.
18. Child friendly, no sharp edge.
19. Does not scratch floors.
20. Provides protection against hold and cold surfaces such as sun.
21. Feces resistant just wipe it off.
22. Sticky resistant if you child smears sticky candy on Cat4play just wash it off.
23. Hearing friendly, very quiet as cats play.
24. Fat cat play house, multiple cats of all sizes can play with large entrance and exits.
25. Extra towers can be purchased to add to frame allowing for anyone to design their way.

### SUMMARY

Cat4play is the only pet play equipment that is environmentally friendly, pet friendly, people friendly, child friendly, cleaner friendly, cost friendly, strength and age friendly, user friendly, decorator friendly, and cats love it and prefer it.

### DRAWINGS—FIGURES

In the drawings FIG. 1A to FIG. 5

FIG. 1A to FIG. 5 is a plurality of predetermined frames of substance that resist pet urine and rust.

FIG. 1A is a square base.

FIG. 1B square tower shaped frame.

FIG. 1C is a frame.

FIG. 1D is a frame.

FIG. 1E is a frame.

FIG. 1F is a frame.

FIG. 1G is a hole.

FIG. 1H is connectors.

FIG. 1I is strip.

FIG. 2 A is a square shaped tower.

FIG. 3 A is EVA foam

FIG. 3 B is Velcro

FIG. 4 EVA foam pad

FIG. 5 EVA foam pet toy

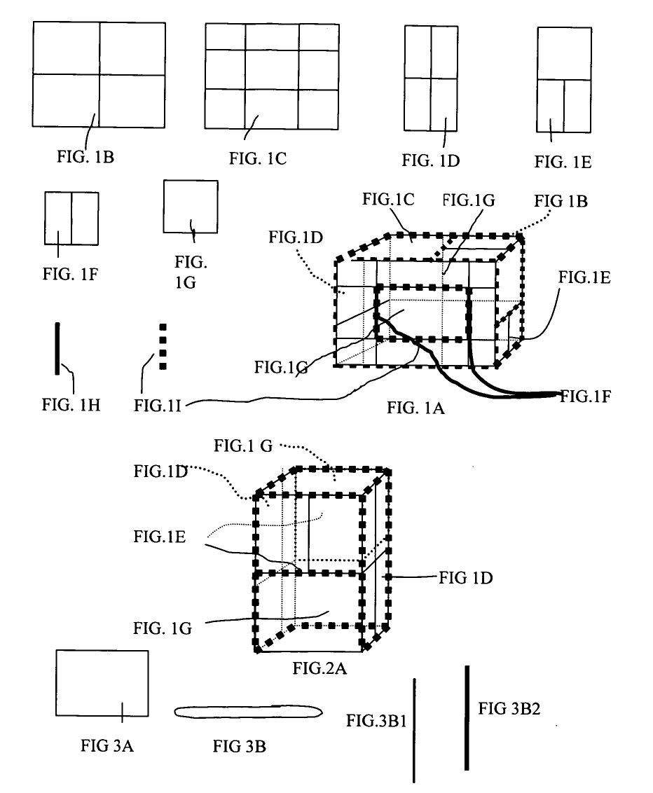

### DETAILED DESCRIPTIONS—FIG. 1 A to FIG. 5

FIG. 1A is the base, 2′×2′, predetermined metal frame of substance, about 3 gauge maybe steel comprising of a predetermined substance that resist rust and pet urine, with about 1′ grid to make a square box shaped base frame with a square tower frame. Base has six pieces, one on top, one on bottom and four on sides. All frames is a predetermined substance that resist pet urine and rust, possible pre welded with predetermined connectors, fig. H. Total height is about 3′ and about 2′ squared wide.

FIG. 1B is about 2′×2′ frame of substance. Means for cat play, exercise and sleep area.

FIG. 1C is about 2′×2′ frame with a predetermined hole in the middle about 1′ squared means of connecting tower to base with Fig. H predetermined connectors.

FIG. 1D is about 1′×2′ frame substance means for sides of square base.

FIG. 1E is about a 1′×2′ frame with a predetermined hole on the end about 1′ squared. Means for entrance and exits and sides for square base.

FIG. 1F is about 1′×1′ frame a flap means for securing center of base strength.

FIG. 1G is about 1′×1′ frame open middle, means to show hole.

FIG. 1 H is predetermined connectors that connect flap to hole FIG. 1G and connectors are also used as a means of connecting toys.

FIG. 1I is a strip of predetermined substance pre attached to all edges to hold second side of Velcro FIG. 3B2. Means of connecting Velcro.

FIG. 2A is the tower, square shaped, about 2′ tall and 1′ wide, made of a predetermined metal substance that resist pet urine and rust comprising of two frames of fig. D and fig. E. Means for extending the height for extra play area.

FIG. 3A Ethylene Vinyl Acetate, foam matting covering outside of base and tower. Means for material that resist pet urine and means for climbing, playing and sleeping.

FIG. 3B Velcro, one side is FIG. 3B1 thin; the opposite side is FIG. 3B2, thick. Means for attaching EVA foam to structure.

FIG. 3A EVA foam matting comes pre assembled with Velcro FIG. 3B2 attached to all edges. Means for easily attaching and detaching EVA foam mats.

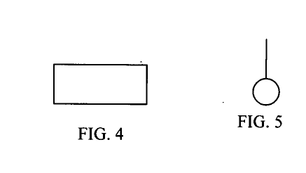

FIG. 4 EVA foam matting is pre cut to fit pet carriers means for safety of pet during transport.

FIG. 5 EVA foam matting is cut into predetermined pet toys, means of non-toxic urine pet resistant and washable toy material.

I claim:

1. Cat4Play is frames for indoor or outdoor, modular, light weight fat cat play house of a square shaped base 2′ tall and 2′ wide with an attached square shaped tower about 2′ tall and 1′ wide covered in a predetermined foam Ethylene Vinyl Acetate matting.

2. The frames of claim 1 wherein said body has a square base and square tower shape and is made of a predetermined substance that resist rust and urine, possible steel frames about 3 gauge wire with about 1′ grid and covered with Ethylene Vinyl Acetate foam about 10 mm thick.

3. The frame of claim 1 is covered with EVA foam matting on the body and tower that emerges thru the grid allowing cats to claw inside and out making two times the area to claw and play with.

4. The frame of claim 1 base and tower are covered with Ethylene Vinyl Acetate foam matting is pre attached with Velcro to all edges with a strip FIG. 3B of a predetermined substance that resist pet urine and rust.

5. The frame of claim 1 is hollow inside the base, means of cat play area.

6. The frame of claim 1 is the base and has two holes of fig. G, enter and exit holes means of chasing in and out.

7. The frame of claim 1 has a center hole fig. G.

8. The frame of claim 1 is a square shaped tower inserted into center hole on top of base.

9. The frame of claim 1 is complete when the tower is attached with predetermined connector's fig. H.

10. The frame of claim 1 is about 2′ tall and 1′ wide square shaped and open at both ends on the tower.

11. The frame of claim 1 is hollow inside tower.

12. The frame of claim 1 is exited and entered by cats thru 2 holes of fig. G on connecting sides of the base.

13. The frame of claim 1 is covered with EVA foam matting that is urine, bacteria, water, and feces, blood resistant.

14. The frame of claim 1 is covered with EVA foam matting and can be disinfected with most popular disinfectants.

15. The frame of claim 1 is easily cleaned, washable with easy drying.

16. The frame of claim 1 is easily replaced with new individual EVA foam mats on the base and tower when damaged.

17. The frame of claim 1 is easily changed into holiday themes, seasons and room décor with individually foam mats.

18. The frame of claim 1 is square shaped, means to fit any corner.

19. The frame of claim 1 is large holes, fig G, large enough for fat cats.

20. The frame of claim 1 is changeable allowing the base to stand on its side means to save floor space and placing the tower beside the base is a means to make Cat4play shorter.

21. I CLAIM the EVA foam matting can be any color, density, shape, and thickness and can be placed anywhere pets come in contact with.

22. EVA foam matting from claim 21 can be pre cut and used inside pet carriers to prevent sliding of pet during transport.

23. The EVA foam matting from claim 22 can be used in any type animal cage to resist wet, hot and cold surfaces.

24. The EVA foam matting from claim 21 can be used for any pet as bedding.

25. The EVA foam matting from claim 21 is comforting for any pet on any substance.

26. The EVA foam from claim 21 can be substituted and used to protect any pet in any situation.

27. The EVA foam from claim 21 can be used and shaped into any pet toy.

28. The EVA foam from claim 21 can be attached to any hole fig. G with connectors fig H means for constant amusement and play.
